(19) United States
(12) Patent Application Publication
(10) Pub. No.: US 2013/0043328 A1
(43) Pub. Date: Feb. 21, 2013

(54) Thermal protector for a sprinkler head

(71) Applicants: David Williams, Houston, TX (US); Jason Williams, Queen Creek, AZ (US)

(72) Inventors: David Williams, Houston, TX (US); Jason Williams, Queen Creek, AZ (US)

(21) Appl. No.: 13/200,057

(22) Filed: Sep. 17, 2011

Related U.S. Application Data
(60) Provisional application No. 61/465,412, filed on Mar. 18, 2011.

(51) Int. Cl. B05B 1/28

(52) U.S. Cl. 239/288

(57) ABSTRACT

One embodiment will protect the sprinkler head 30 from heat during the kill process of bed bugs. The embodiment is installed with temperature indicators to show if the maximum ceiling temperature has been exceeded and has compromised the thermal element. The seal between the embodiment and sprinkler head is made between the adapter ring 40, the sprinkler support cup assembly 180, the escutcheon cup 150, or the supply pipe 20. Installation of the embodiment never impairs the sprinkler head 30.

### CROSS REFERENCE TO RELATED APPLICATIONS

This application claims the benefit of provisional patent application Ser. No. 61/465,412 filed 2011 Mar. 18 by the present inventors, which is incorporated by reference.

### BACKGROUND

1. Prior Art

The following is a tabulation of some prior art that presently seems relevant:

2. Nonpatent Literature Documents

Web Site of Temp-Air™, Inc (www.thermal-remediation.com/bed-bugs/equipment-packages-accessories.aspx) describing sprinkler head covers.

3. Background

A major concern today for the hospitality and hotel industry is the infestation of bed bugs. In order to euthanize the bugs, the rooms must be heated to at least 120° F. Bed bugs are very sensitive to temperature. If the insect and eggs are exposed to temperatures above 115° F. or below 32° F., the insect will die within ten to twenty minutes. The two main types of heat treatment are steam and thermal heating. Heating is the safest, least expensive, and most effective way to control bed bugs. The room is soaked for 24 hours and this allows the heat to penetrate all the hiding places of the bed bug. However, heating the room also exposes the ceiling and sprinkler head assembly to 120° F.

| Maximum | | | | |
|---|---|---|---|---|
| Ceiling | Temperature | Temperature | | Glass Bulb |
| Temperature | Rating | Classification | Color Code | Colors |
| ° F. | ° F. | | | |
| 100 | 135-170 | Ordinary | Uncolored or | Orange or |
| | | | black | red |
| 150 | 175-225 | Intermediate | White | Yellow or |
| | | | | green |
| 225 | 250-300 | High | Blue | Blue |
| 300 | 325-375 | Extra high | Red | Purple |
| 375 | 400-475 | Very Extra | Green | Black |
| | | High | | |
| 475 | 500-575 | Ultra High | Orange | Black |
| 625 | 650 | Ultra High | Orange | Black |

Based on NFPA 13 Table 6.2.5.1

Referring to the Table 6.2.5.1, the maximum ceiling temperature of a sprinkler head classified as “ordinary” cannot exceed 100° F. Ambient temperatures in excess of these maximums would cause stress in the thermal element, eventually weakening its load-carrying capacity with the result that the sprinkler may fire prematurely. The accepted practice is to drain the sprinkler system and remove the sprinkler heads and replace them with higher-temperature-rated heads or pipe plugs. Recently, sprinkler heads have been wrapped with temporary insulation to protect the sprinkler from excessive ambient temperature, but this comes with risks. Wrapping the sprinkler can compromise the glass bulb and fusible link by distorting the sprinkler body. These methods are time-consuming, costly, and dangerous. What is needed is a cover that encapsulates the head and prevents the temperature around the bulb from ever reaching the maximum ceiling temperature.

The prior art for sprinkler head protection has three avenues. One is to cover the sprinkler head by flat cover plates where aesthetics are a primary consideration. The plate must fall away during a fire so that the head can be exposed to the hot gases. The second is a protective sprinkler guard to protect from mechanical or physical damage but allows hot gases to reach the sprinkler head. The third is a disposable protective cup that will be removed after installation. There are many of these types of contraptions U.S. Pat. No. 3,393,746 Fusible Apparatus for Protecting Automatic Sprinkler, U.S. Pat. No. 3,797,746 Sprinkler Guard, U.S. Pat. No. 3,998,273 Apparatus for Use With a Fire Safety Device, U.S. Pat. No. 6,669,111 Protection for Thermally Responsive Member of Sprinkler Head, etc. All prior art to present focuses on getting the hot gases to the sprinkler head. Our embodiment, on the other hand, focuses on the contrary by preventing hot gases from contacting the sprinkler head. Because of the contrary nature of our cover, the prior art is sparse. Temp-Air™ located in Burnsville, Minn. provides a sprinkler head cover to protect the thermal element. (See www.thermal-remediation.com.) The cover is an insulated foam box open at one end with a pull cord. The cord on the inside has a loop to hang around the sprinkler head. The cord extends to the outside of the box for pulling. To install, the loop is placed over the head and the box is pulled into place—over the sprinkler head—by the external cord. The cord is pulled tight to seat the box against the ceiling. This device has a number of drawbacks:
(a) Ceilings are never smooth and are rough from the texturing. It is doubtful this contraption can provide a seal at the ceiling.
(b) The cord acts as a tether to the sprinkler head and as the cord heats from the kill process, the cord will slacken causing the seal between the box and ceiling to deteriorate. During the soaking of the room, heat will accumulate at the ceiling. Any opening around the ceiling and foam box will allow the temperature inside the box to stabilize to the kill temperature.
(c) NFPA 25 says sprinklers are impaired if “Leaking, heavily corroded, painted operating element or bulb or deflector or cover plate, heavily loaded, foreign materials attached to or suspended from, improper orientation, glass bulbs that have lost fluid.” Also, NFPA 25-5.2.2.2 says “Sprinkler piping shall not be subjected to external loads by materials either resting on the pipe or hung from the pipe.”
(d) Cord tension can cause distortion in the body of the head, distorting the fragile glass bulb, and causing it to fire prematurely. Potential also exists where the cord could catch on the fragile teeth and distort the deflector compromising the spray pattern.
(e) A sensor is needed to confirm that the temperature inside the box didn't exceed the maximum ceiling temperature.
(f) A permanent record of the temperature inside the box is needed.

Other vendors are using masking tape to tape the box to the ceiling. Masking tape is not an effective means of sealing the box.

### SUMMARY

In accordance with one embodiment, a thermal protector for a sprinkler head comprises an insulated cup, temperature indicator, and seal.

### ADVANTAGES

Accordingly, several advantages of one or more aspects are as follows:
(a) Provides a tight seal so that the sprinkler head environment is isolated from the kill environment.
(b) Provides a self-energizing seal.
(c) Indicates a high ceiling temperature inside the sprinkler head environment. Indication is provided by using either a Pop-up™ indicator or irreversible temperature label.
(d) Provides a permanent record.
(e) Provides a low cost and effective way to isolate a sprinkler head.
(f) Adapts to the many styles of sprinkler heads.
(g) Does not come in contact with sprinkler head. The sprinkler head is not impaired as defined in Table E.1 of NFPA 25.
(h) Provides reuse of cups.
(i) Is made from recyclable materials.

### DRAWINGS—FIGURES

In the drawings, closely related figures have the same number but different alphabetic suffixes.

FIG. 1a shows a recessed pendent sprinkler head, supply pipe, and recessed escutcheon.

FIG. 1b shows the escutcheon removed from recessed sprinkler head assembly and the first embodiment mated to the adapter ring.

FIG. 2a shows a flush pendent sprinkler head, supply pipe, and flush escutcheon.

FIG. 2b shows the escutcheon removed from flush pendent sprinkler head and the first embodiment mated to the adapter ring.

FIG. 3a shows a concealed pendent sprinkler, supply pipe, support cup assembly, and cover plate.

FIG. 3b shows the cover plate removed and the second embodiment mated to the support cup assembly.

FIG. 4a shows an extended pendent sprinkler head, supply pipe, two-piece escutcheon, and reducer.

FIG. 4b shows an escutcheon cup mated with the third embodiment. FIG. 5a shows a magnetic cup of a fourth embodiment stuck to the

metal recessed escutcheon.

FIG. 5b shows an end view of the fourth embodiment.

FIG. 6a shows a flush escutcheon paired with a cup and insulated cover plate of the fifth embodiment.

FIG. 6b shows the side view of the fifth embodiment.

FIG. 6c shows a top view of the fifth embodiment.

FIG. 7a shows the sixth embodiment mated with a recessed pendent sprinkler head.

FIG. 7b shows the side view of the sixth embodiment.

FIG. 8a shows a side view of another version of an extended pendent sprinkler head with seventh embodiment disassembled.

FIG. 8b shows a side view of another version of an extended pendent sprinkler head with seventh embodiment assembled.

FIG. 8c shows side view of female section of seventh embodiment.

FIG. 8d shows side view of male section.

### DRAWING—REFERENCE NUMERALS

10. Drywall.

20. Supply pipe.

30. Sprinkler head assembly.

40. Inner adapter ring.

50. Escutcheon.

60. Male threads.

70. Pipe coupling.

80. Annular space around drywall.

90. Spring tabs.

100. Insulated cup.

105. Hole for Pop-up™ indicator.

110. Pop-up™ indicator.

120. Seal.

130. Spring steel.

140. Insulated cover plate.

150. Escutcheon cup.

160. Pipe reducer.

170. Skirt.

180. Sprinkler support cup assembly.

190. Solder tabs.

200. Retaining ring.

210. Cover plate assembly.

220. Magnets.

230. Temperature label.

240. Cover plate.

250. Deflector.

260. Corrugated threads.

270. Soft, pliable material.

280. Two piece insulated cup.

290. Female section.

295. Male section.

300. Recessed face.

310. Raised face.

320. Cavity.

330. Hole for supply pipe.

340. Groove.

350. Releasable cable tie.

360. Hole for Pop-up™ indicator.

In the following descriptions, two objectives to ensure that the insulated cup 100 should not leak heat must be met. First an insulated cup 100 must be of the proper insulating material and thickness. Second the seal must not allow heat to enter the inside of the cup.

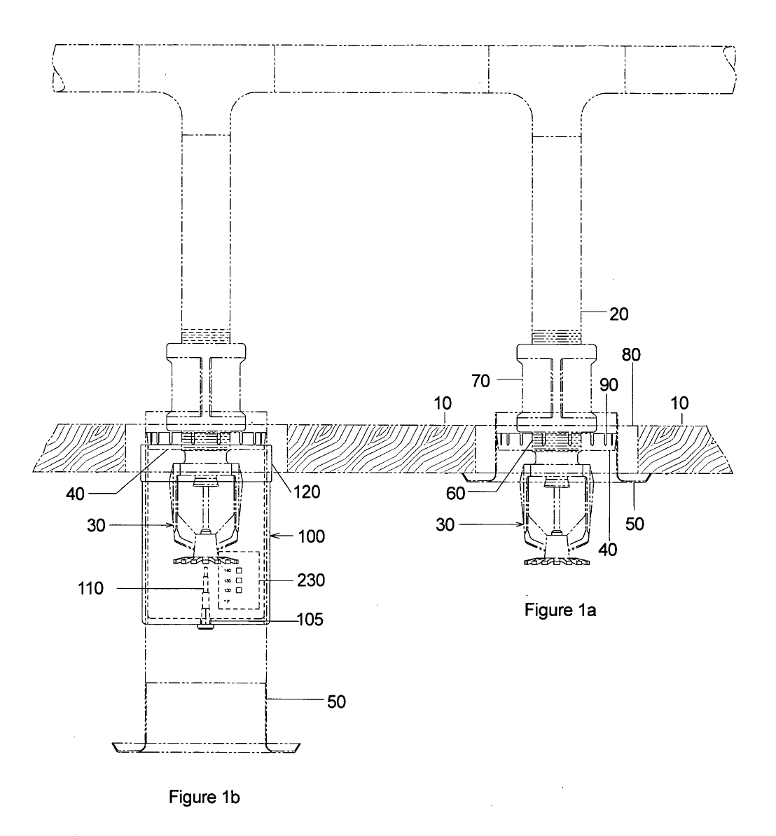

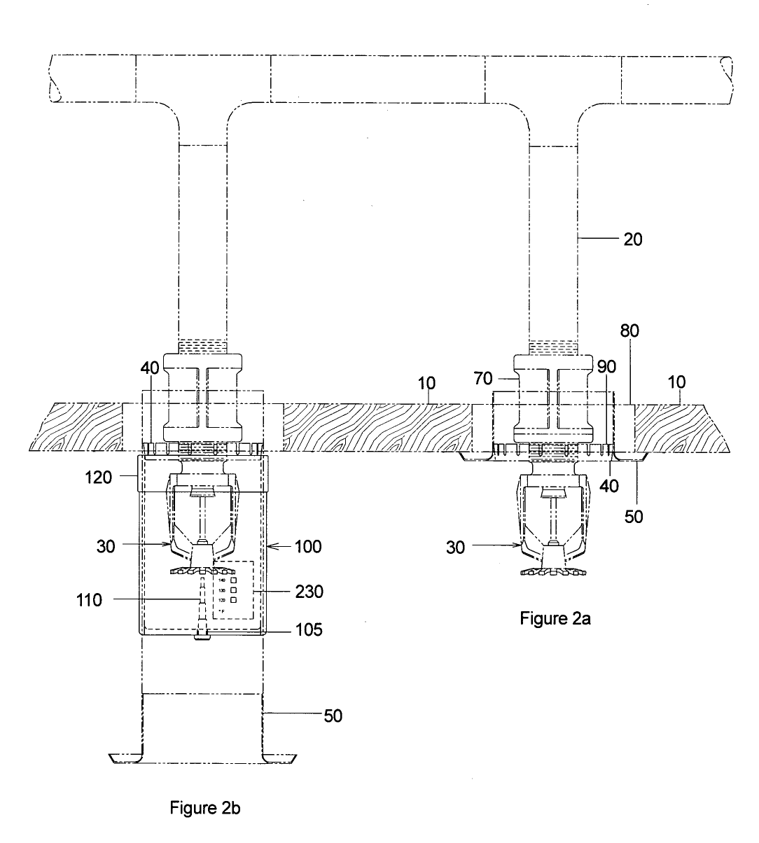

### Detailed Description—FIG. 1a, FIG. 1b, FIG. 2a, and FIG. 2b—First Embodiment

FIG. 1a shows a side view of a popular recessed pendent sprinkler head 30. It is considered recessed because an adapter ring 40 is above the bottom surface of a drywall material 10. The location of the adapter ring 40 in the recess of an escutcheon 50 is determined by the installed length of a water supply pipe. The height of the ring 40 will vary from sprinkler head to sprinkler head. To assemble, the inner ring adapter 40 is twisted onto a series of male threads 60 of the sprinkler head 30. The sprinkler head male threads 60 are twisted into a coupling 70 that is attached to a supply pipe 20. The outer escutcheon 50 is then shoved into a hole 80 cut in the drywall 10, over a plurality of spring tabs 90 of the inner adapter ring 40 until it is firm against the drywall 10. The spring-loaded tabs 90 bear against the escutcheon 50 and keep it secured in the hole. The spring-loaded tabs 90 are a temporary locking device which allows the escutcheon 50 to be removed at a later date to maintain the sprinkler head 30.

FIG. 1b shows the first embodiment paired with the adapter ring 40. The first embodiment is comprised of the insulated cup 100 that contains a Pop-up™ indicator 110. The Pop-up™ indicator 110 could also have a companion temperature label 230 located on the inside of the cup 100. Temperature labels have an adhesive on the back so that the device can be attached to the inside of the insulated cup 100. FIG. 1b also shows the escutcheon 50 removed from the drywall 10. This allows the insulated cup 100 to be paired with the adapter ring 40. The Pop Up™ indicator 110 should have a tolerance of +−0.5° F. The maximum temperature of the indicator 110 would be set at (ceiling temperature −0.5) and this would guarantee the integrity of the bulb of the sprinkler head 30. The indicator 110 can be positioned through a hole 105 either in the bottom or the side of the insulating cup 100 with the button of the Pop-up™ indicator 110 facing into the kill environment. A seal 120 is made thicker to add mechanical strength for distortion caused by the shoving and twisting of the cup 100 onto the adapter ring 40. The Pop-up™ indicators 110 can be purchased from Volk Enterprises of Alpharetta, Ga. 30004. Temperature labels can be purchased from Omega Engineering of Atlanta, Ga 30384.

FIG. 2a shows a side view of a flush pendent sprinkler head. The assembly of the flush pendent sprinkler is exactly the same as the recessed sprinkler head except the supply pipe 20 must be cut to the exact length.

FIG. 2b shows the first embodiment paired with the adapter ring 40. FIG. 2b also shows the escutcheon 50 removed from the drywall 10 to allow for the installation of the first embodiment.

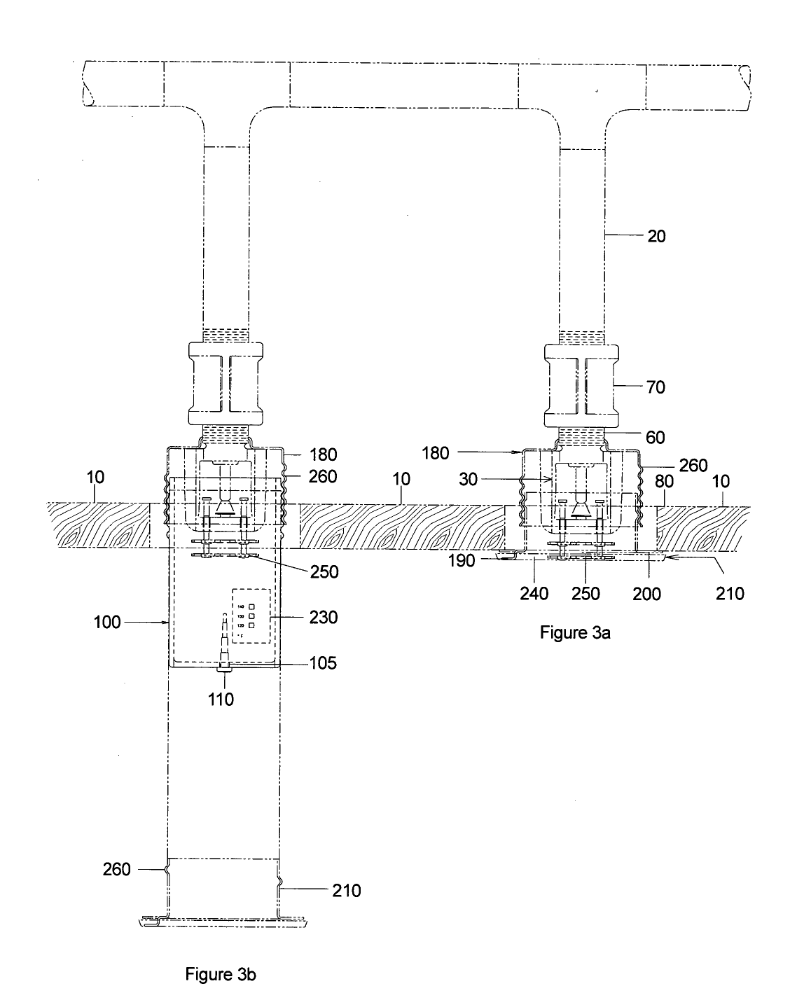

### Detailed Description—FIG. 3a and FIG. 3b—Second Embodiment

FIG. 3a is a side view of a concealed pendent sprinkler. The sprinkler head 30 is encapsulated in a sprinkler support cup assembly 180 and the open end is covered with a cover plate assembly 210. This type is used in architecturally sensitive areas such as hotel rooms, casinos, churches, restaurants, and hotel lobbies. A cover plate 240 is attached to the cover plate assembly 210 by solder and a plurality of solder tabs 190. When the hot gases reach the fusion temperature, the cover plate 240 falls away and a deflector 250 drops down into position. The cover plate assembly 210 and the sprinkler support cup assembly 180 are provided with a type of corrugated threads 260 so that the cover assembly 210 can be turned into the support cup 180 until a retaining ring 200 is flush with the bottom of the drywall 10.

FIG. 3b shows the cover plate assembly 210 removed from the support cup assembly 180. The second embodiment is comprised of the insulated cup 100 that contains the Pop-up™ indicator 110, and the corrugated threads 260. The indicator 110 can be positioned through the hole 105 either in the bottom or the side of the insulating cup 100 with the button of the Pop-up™ indicator 110 facing into the kill environment. The Pop-up™ indicator 110 could also have the companion temperature label 230 stuck to the inside of the cup 100. The corrugated threads 260 on the insulated cup 100 can either be external or internal, allowing the cup 100 to be twisted onto or into the support cup assembly 180. The insulated cup 100 can also be manufactured without threads. The inside diameter (ID) or outside diameter (OD) of the cup 100 would match the OD or ID of the support cup assembly 180.

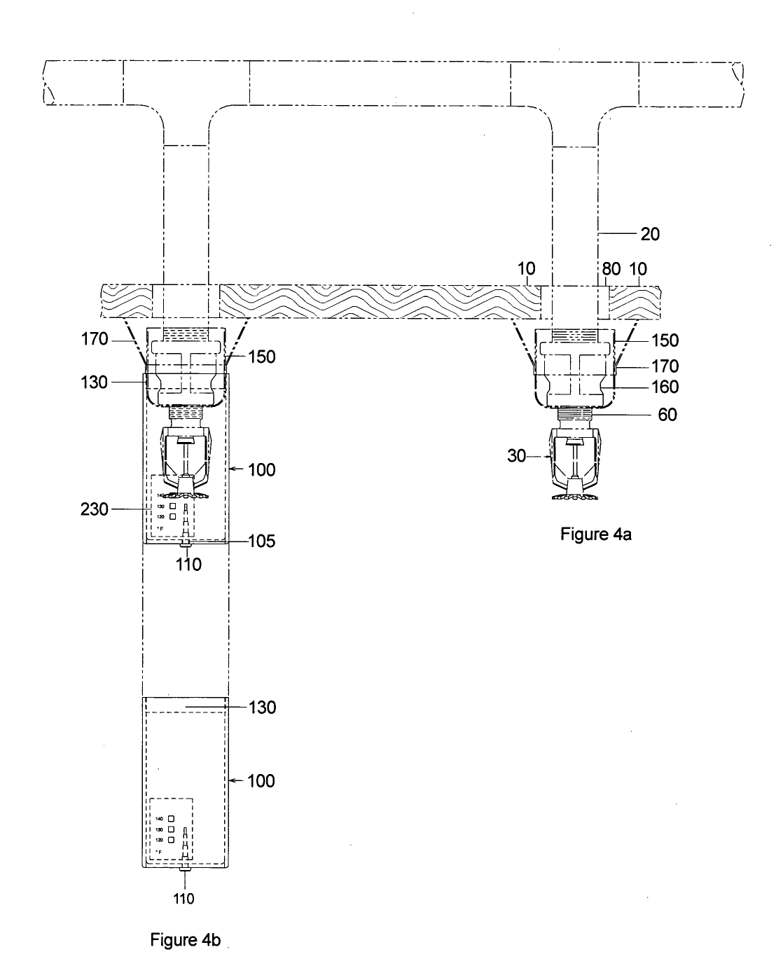

### Detailed Description—FIG. 4a and FIG. 4b—Third Embodiment

FIG. 4a is a side view of an extended pendent sprinkler head. A two-piece adjustable escutcheon is used to hide the supply pipe 20 and a reducer 160. The two-piece escutcheon is comprised of an escutcheon cup 150 and a skirt 170. The sprinkler head 30 is twisted into the escutcheon cup 150, and then the sprinkler head 30 is turned into the pipe reducer 160. The skirt 170 slides over the escutcheon cup 150 to provide adjustment to the bottom of the ceiling. The two-piece escutcheon is also used on dry-type sprinklers where the sprinkler head 30 is exposed to freezing temperatures.

FIG. 4b shows the third embodiment comprised of the insulated cup 100, the Pop-up™ indicator 110, and the temperature label 230. The indicator 110 can be positioned through the hole 105 either in the bottom or the side of the insulating cup 100 with the button of the Pop-up™ indicator 110 facing into the kill environment. The open end of the insulated cup 100 has an embedded thin spring steel ring 130 to add strength to the open end of the cup 100. The spring steel ring 130 should be approximately 0.003 inch thick. The purpose of the spring steel ring 130 is to provide strength and also provide a metal-to-metal surface of contact between the escutcheon cup 150 and inner surface of the cup 100. This feature could be added to any of the embodiments to add strength to the insulated cup 100.

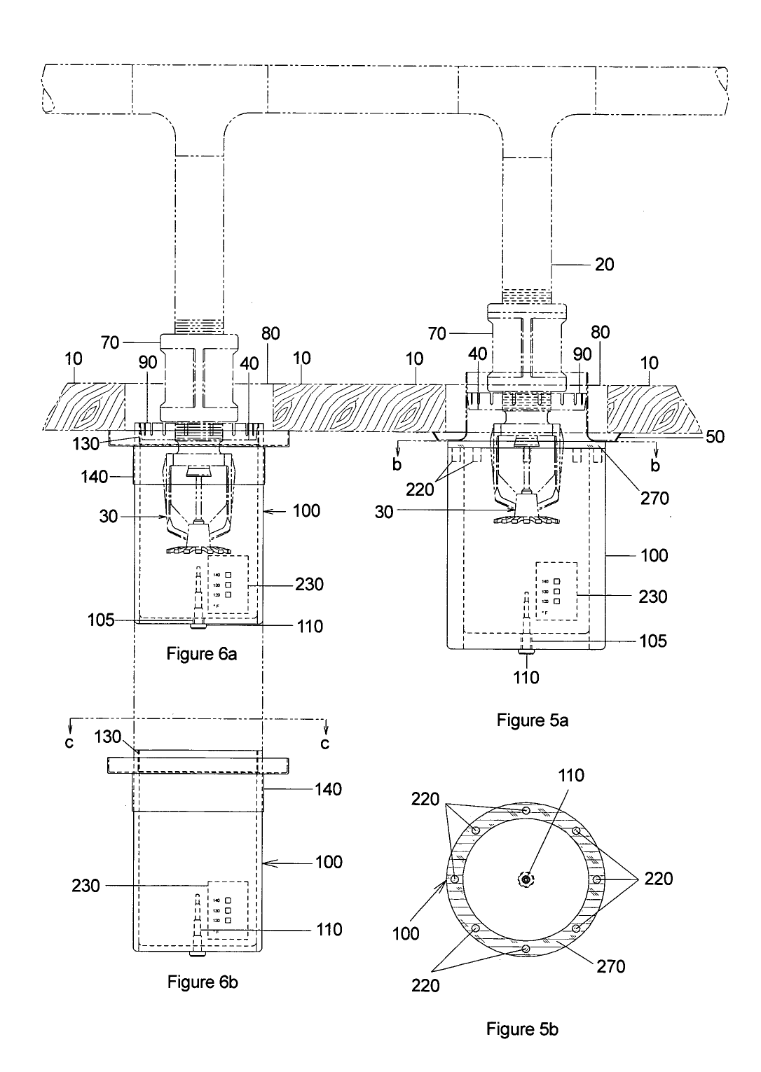

### Detailed Description—FIG. 5a and FIG. 5b—Fourth Embodiment

FIG. 5a is a side view of the recessed pendent sprinkler head 30 and the installed insulated cup 100. The recessed pendent sprinkler head 30 has been described in detail under the first embodiment. The fourth embodiment comprises the insulated cup 100, the Pop-up™ indicator, the temperature label 230, a soft, pliable material 270, and a circular array of magnets 220. The indicator 110 can be positioned through the hole 105 either in the bottom or the side of the insulating cup 100 with the button of the Pop-up™ indicator 110 facing into the kill environment. The temperature label 230 is placed on the inside of the insulated cup 100. Small cylindrical magnets— 1/16^{th} inch round×¼ inch long—can purchased from Emovendo Magnets and Elements, Petersburg, W. Va. 26847. (See www.emovendo.net). The magnets 220 are embedded in the insulated material at the open end of the insulated cup 100. On the end of the cup 100, the soft, pliable material 270, such as sponge rubber or felt, is secured. This material will provide a seal between the escutcheon 50 and the insulated cup 100. NFPA 13 6.2.7.1 states, “Plates, escutcheons, or other devices used to cover the annular space around a sprinkler shall be metallic or shall be listed for use around a sprinkler.” Since the covers 240 and the escutcheons 50 are metal, this embodiment could be used on any of the embodiments.

FIG. 5b is an end view of the fourth embodiment showing the soft, pliable material 270, the magnets 220, and the insulated cup 100. The soft, pliable material 270 is permanently attached to the insulated cup 100.

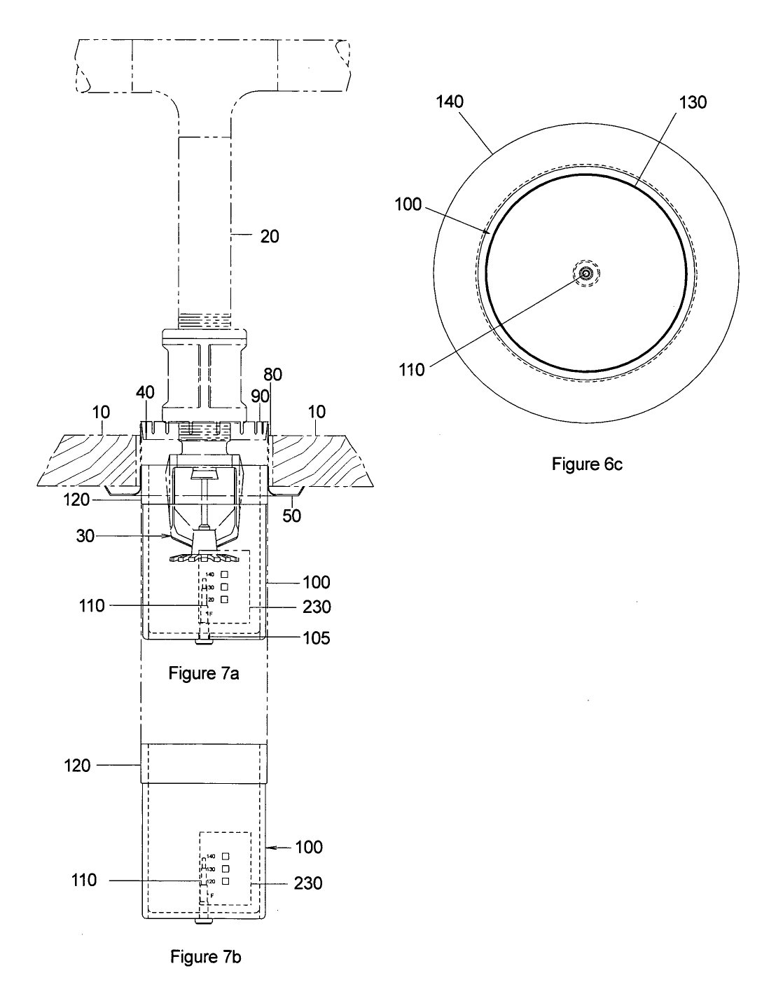

### Detailed Description—FIG. 6a and FIG. 6b—Fifth Embodiment

FIG. 6a shows the side view of the flush pendent sprinkler head 30 and the installed insulated cup 100. The flush pendent sprinkler head 30 has been described in detail under the second embodiment. FIG. 6b shows a two-piece arrangement—the insulated cup 100 and an adjustable cover plate 140. The fifth embodiment comprises the insulated cup 100, the Pop-up™ indicator 110, the temperature label 230, the spring steel ring 130, and the adjustable cover plate 140. The indicator 110 can be positioned through the hole 105 either in the bottom or the side of the insulating cup 100 with the button of the Pop-up™ indicator 110 facing into the kill environment. The open end of the insulated cup 100 has the embedded thin spring steel ring 130 facing inward toward the centerline of the insulated cup 100. The insulated cover plate 140 can be moved up and down the full length of the insulated cup 100. The purpose of the insulated cover plate 140 is to cover the hole in the ceiling after the insulated cup 100 is installed. FIG. 6c is an end view of the fifth embodiment. This arrangement could be used on all the embodiments where the hole 80 is open to the kill environment.

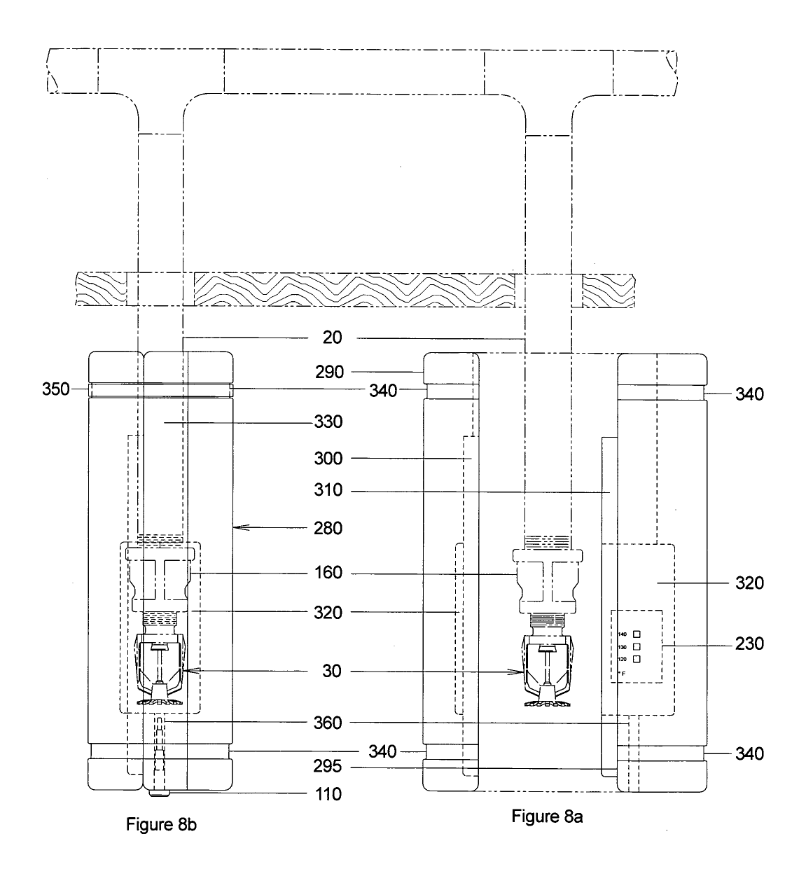

### Detailed Description—FIG. 7a and FIG. 7b—Sixth Embodiment

FIG. 7a is a side view of the recessed pendent sprinkler head 30 and the sixth embodiment. The recessed pendent sprinkler head 30 has been described in detail under the first embodiment. The sixth embodiment is comprised of the insulated cup 100, the Pop-up™ indicator 110, the temperature label 230, and the thickened seal 120. The difference between this embodiment and the aforementioned embodiments is that the sealing surface is on the outside diameter of the insulated cup 100.

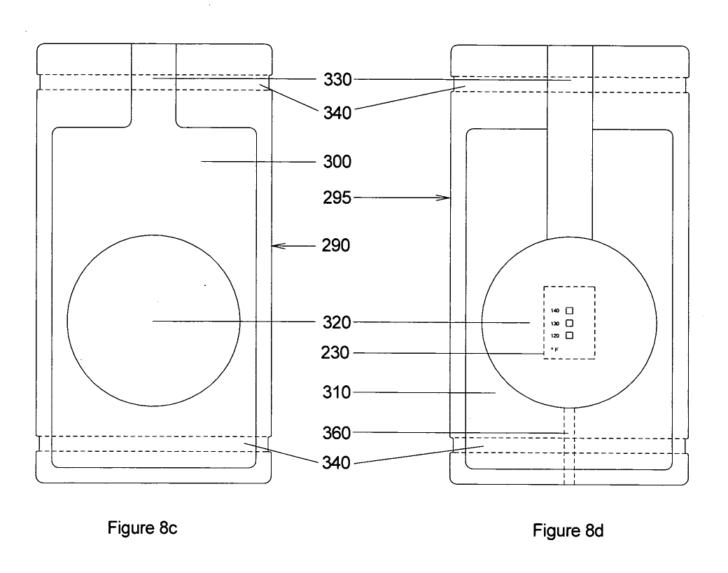

### Detailed Description—FIG. 8a, FIG. 8b, FIG. 8c, and FIG. 8d—Seventh Embodiment

FIG. 8a is a side view of another version of the extended sprinkler head 30. In this case the supply pipe 20 is too long for the two-piece escutcheon cup 150 and the skirt 170. Two-piece escutcheons will have a maximum extension of about 2⅞ inches. The seventh embodiment is used in cases where the supply pipe is too long for the standard two-piece escutcheon. The seventh embodiment comprises a two-piece insulated cup 280, a female section 290, a male section 295, the Pop-up™ indicator 110, the temperature label 230, and a releasable cable tie 350. FIG. 8a shows the two-piece insulated cup 280 separated. The female section 290 receives and holds the male section 295 by a recess face 300 and a raised face 310. When joined, this joint provides an airtight seal around the reducer 160 and the sprinkler head 30. A cavity 320 is provided on both the female section 290 and the male section 295. The cavity 320 is provided with ample volume so that when both sections are joined, the two-piece insulated cup 280 clears the reducer 160 and the sprinkler head 30. The cavity 320 should leave material on the recess face 300 and the raised face 310 so that a seal can be made. A hole 330 is provided to accommodate the supply pipe 20. To provide a seal between the supply pipe 20 and the insulated cup 280, the hole 330 is molded slightly smaller than the OD of the supply pipe 20. A hole 360 is provided for the insertion of the Pop-up™ indicator 110. The companion temperature label 230 can also be provided with the Pop-up™ indicator 110. A groove 340 is furnished on both top and bottom of the two-piece insulated cup 280. The purpose of the groove 340 is to receive the releasable nylon cable tie 350.

The materials for use in all of the aforementioned embodiments could be Styrofoam™ (Styrofoam™ is a trademark of Dow Chemical), expanded polystyrene, extruded polystyrene, paper products, plastics, or any material that retards heat flow. Styrofoam™ has been selected because it is an old-line product with many manufacturers available to form or mold it. It is an inexpensive material, sturdy, a good insulator, and pliable. A company such as Universal Foam Products can provide many types of Styrofoam™ products.

Operation FIGS. 1a, 1b, 2a, 2b, 6a, 6b, 6c

The installer would remove the escutcheon 50 as shown in FIG. 1b and FIG. 2b and grasp the lower end of the insulating cup 100 until it is positioned on the inner adapter ring 40. By twisting and shoving the insulated cup 100, a seal is made between the inner adapter ring 40 and the insulated cup 100. The spring tabs 90 will bite into the insulating material, creating an even tighter seal. For units that are fitted with the spring steel ring 130, the metal-to-metal contact will seal the sprinkler head environment.

Hot air is prevented from entering the inside of the cup by the interference between the insulated cup 110 against the inner adapter ring 40. To seal the hole in the drywall 10, the insulated cover 140 is used. The insulated cover 140 is adjusted along the length of the insulated cup 100 until the insulated cover 140 is flush with the bottom of the drywall 10. Irreversible labels and Pop-up™ indicators change appearance once a certain temperature is reached. This provides a confirmation that the sprinkler head 30 has not exceeded the maximum ceiling temperature.

FIG. 3a, 3b

To install the second embodiment, the cover plate assembly 210 is unfastened by turning to the left the cover plate assembly 210. After the cover plate 210 is removed, the insulated cup 100 is twisted into or onto the support cup assembly 180. The corrugated threads will provide the seal between the support cup assembly 180 and the insulated cup 100.

If the cup 100 is not provided with corrugated threads, then the cup 100 is pushed into or onto the support cup assembly 180. The cup 100 would then be shoved and twisted until the top is flush with the bottom of the support cup assembly 180 or if the cup mates on the outside of the support cup assembly 180, until a height is reached that will give adequate sealing.

Hot air is prevented from entering the inside of the cup by the interference between the corrugated threads 260 of the insulated cup 110 against the corrugated threads 260 of the support cup assemble 180. To seal the hole in the drywall 10, the insulated cover 140 is used. The insulated cover 140 is adjusted along the length of the insulated cup 100 until the insulated cover 140 is flush with the bottom of the drywall 10.

Excessive temperatures inside the cup would be shown by the Pop-up™ indicator 110 or irreversible label 230.

FIG. 4a, 4b

The insulated cup 100 is shoved and twisted onto the escutcheon cup 150 until the top of the cup 100 is flush with the bottom of the skirt 170. In cases where the skirt is missing, the insulated cup 100 would be pushed until it is flush with the drywall 10. The insulated cover plate 140 could be used to cover the hole 80. Hot air is prevented from entering the inside of the cup by the interference between the spring steel band 130 and the escutcheon cup 150.

Excessive temperatures inside the cup would be shown by the Pop-up™ indicator 110 or irreversible label 230.

FIG. 5a, 5b

The insulated cup 100 is aligned and brought close to the escutcheon 50 until the magnets grab the metal escutcheon 50. The seal is made with the pliable material 270.

Excessive temperatures inside the cup would be shown by the Pop-up™ indicator 110 or irreversible label 230.

FIG. 7a, 7b

To install the sixth embodiment, the insulated cup 100 is shoved and twisted into the recess of the escutcheon 50. Hot air is prevented from entering the inside of the cup by the interference between the thicken seal 120 and the escutcheon 50.

Excessive temperatures inside the cup would be shown by the Pop-up™ indicator 110 or the irreversible label 230.

FIG. 8a, 8b, 8c, 8d

The two-piece insulated cup 280 is parted and aligned so that the cavity 320 covers the sprinkler head 30 and the reducer 160. The alignment must also allow the supply pipe 20 to fit inside the hole for the supply pipe 330. The female section 290 and the male section 295 are merged together as a whole by inserting the raised face 310 of the male section 295 into the recessed face 300 of the female section 290. Both the female section 290 and the male section 295 are squeezed together until flush. Two releasable cable ties 350 are placed in the two grooves 340 and are pulled tight. This will secure both halves and provide a seal against the ingress of heat. Insert the Pop-up™ indicator 110 into the hole 360.

General Discussion of all Figures

Seals can be classified two ways—forced seal and self-energized. The forced seal requires an outside agent to seat the gasket. The aforementioned prior art is an example of a forced seal where the string is used to urge the gasket against the ceiling. Self-energized seals, on the other hand, depend on the deformation of an elastic material to create a joint between the sealing faces. All of the embodiments use this principle to seal the sprinkler head environment. The inside diameter of the elastic insulated cup 100 is made slightly smaller than the adapter ring 40 or the escutcheon cup 150. In the case of embodiment six, the outside diameter of the insulated cup 100 is made slightly larger. When the insulated cup 100 is installed, the internal forces in the cup 100 are either in compression or tension causing the surfaces to have intimate contact and thus sealing. If hot air does enter the inside of the insulated cup 100 due to damaged insulating material, misalignment of the seals, or other unknowns, the Pop-up™ indicator 110 will fire, showing the defective sprinkler head. Theoretically, it could be shown that the temperature drop across the insulating material is great enough to ensure that the temperature around the bulb would never exceed the maximum ceiling temperature. However, due to the stringent inspections given to fire systems, there would always be a certain amount of doubt as to whether the bulb was below its maximum ceiling temperature during the kill process. To make doubly sure the bulb is protected, the Pop-up™ indicator 110 is installed to fire before the temperature exceeds the maximum ceiling temperature limit. If the sprinkler heads 30 are installed in the ceiling and the temperature exceeds the maximum, the button of the Pop-up™ indicator 110 would be visible from the floor.

If the temperature label 230 were installed, this device would provide a permanent record of the temperature inside the insulated cup 100.

The temperature label 230 can be installed on the outside of the insulated cup to show the ceiling temperature.

Conclusion, Ramifications, and Scope

Thus the reader will see that at least one embodiment of the thermal protector provides a reliable, lightweight, economical, and easily installed device that can be used by workmen in the field.

While our above description contains many specifics, these should not be construed as limitations on the scope, but rather as an exemplification of one or several embodiments thereof. Many other variations are possible. For example, the insulated cup 100 could be used without temperature indicators. To increase the resistance to heat, thin thermal barriers such as paints and films could be applied to the inside of the cup. Foams could be sprayed inside the cup to increase the resistance to heat. The foams would have the consistency of whipped cream. Then the foam would be removed by vacuum or water spray. Ice substitutes such as Freez Pak™ of Peterson, N.J. 07501 or Ice Pak™ of Vernon, Ill. 60061 could be manufactured integrally with the insulated cup 100. The cups 100 could be placed in a freezer before use to freeze the cold packs. Wireless thermocouples could be placed in every cup and a temperature recorder used to monitor the temperatures during the kill process. This arrangement could also provide a plot—time versus temperature—for the insulated cups 100. There may be a way to provide an adjustable opening on the insulated cup 100 so that it would fit many variations of sprinkler head assemblies. The shape of the insulated cup 100 may be changed to impede heat flow. To strengthen the insulated cup 100, fibers could be used integrally with the insulating materials. The Pop-up™ indicator 110 could be provided with a piece of material over the button. This would provide a tamper-proof indicator. The Pop-up™ 110 indicator could be used only once. An audible buzzer could replace the temperature indicators. The insulated cup 100 could be of laminate construction—thin plastic coating both inside and outside. There may be a way to bring a thin optical fiber from the inside of the cup to the outside of the cup. Then using a handheld infrared thermometer, the temperature on the inside of the insulated cup 100 could be measured. Another method of attaching the cup 100 to the escutcheon 150 could utilize a plurality of tabs at the opening of the cup 100. The tabs could be inserted between the drywall 10 and the escutcheon 50. The end of the cup 100 would have the soft, pliable material 270 affixed to the top of the cup 100 to seal against the drywall 10. Another method of attaching the insulated cup 100 to the ceiling is to provide an array of sharp pins embedded in the open end of the insulated cup 100. An installer would push the insulated cup 100 until the pins embed themselves into the ceiling. The insulated cup 100 would have at the open end the soft, pliable material 270 to affect the seal.

1. A insulated container for protecting a sprinkler head from heat comprising:
a. an open end with an attaching means for mating the container to an escutcheon of a sprinkler head, and
b. the open end has a sealing means for providing an interference between the open end of the container and the face of the escutcheon caused by tension or compression of the sealing means,
whereby, the container is attached to the sprinkler head unit without impairing the operation of the sprinkler head.
1a. The insulated container of claim 1, further including arrangements taken from a set containing a pop-up indicator, a temperature label, a wireless thermocouple, audible buzzer, or a fiber cable with light emitting diode.
1b. The insulated container of claim 1 wherein the insulated container is manufactured from a material selected from the group consisting of Styrofoam, expanded polystyrene, extruded polystyrene, insulated paper products, plastics, felts, polyurethane foams, crosslinked foam, fiberglass, hemp, plastic foam, or any material that retards the flow of heat.
1c. The insulated container of claim 1 wherein the insulated container is manufactured from a material selected from the group consisting of fiberglass foam composites, composite-reinforced foam, fiber tape reinforced foam, nylon reinforced foam, carbon reinforced foam, paperboard, pressboard, cloth laminated sheet, corrugated board, braided fiberglass, or fiber paper.
1d. The insulated container of claim 1, further including an integral ice substitute located in the hollow of the insulated container.
1e. The insulated container of claim 1, further including an adjustable Insulating means for covering or plugging a hole in a ceiling or a wall by sliding along the full length of the insulated container.
1f. The sealing means of claim 1 wherein the sealing means is a self-energized barrier taken from the group consisting of corrugated threads, integral elastic bands, spring energized seals, O-rings, and integral metallic-elastomer seals
whereby, the sealing force is generated by the deformation of the insulated container causing the integral seal to interfere tightly with the escutcheon or pipe.

2. A two-piece insulated container for protecting a sprinkler head from heat comprising:
a. a recessed or female piece with a cavity to surround the sprinkler head unit and hole to accommodate a supply pipe,
b. a raised or male piece with a cavity to surround the sprinkler head unit and hole to accommodate the supply pipe, and
c. an attaching means for providing a plurality of interference fits by joining the female piece with the male piece
whereby, the container is attached to the sprinkler head unit without impairing the operation of the sprinkler head.
2a. The two-piece insulated container of claim 2, further including arrangements taken from a set containing a pop-up indicator, a temperature label, a wireless thermocouple, audible buzzer, or a fiber cable with light emitting diode.
2b. The two-piece insulated container of claim 2 wherein the two-piece insulated container is manufactured from a material selected from the group consisting of Styrofoam, expanded polystyrene, extruded polystyrene, insulated paper products, plastics, felts, polyurethane foams, cross-linked foam, fiberglass, hemp, plastic foam, or any material that retards the flow of heat.
2c. The two-piece insulated container of claim 2 wherein the two-piece insulated container is manufactured from a material selected from the group consisting of fiberglass foam composites, composite-reinforced foam, fiber tape reinforced foam, nylon reinforced foam, carbon reinforced foam, paperboard, pressboard, cloth laminated sheet, corrugated board, braided fiberglass, or fiber paper.
2d. The two-piece insulated container of claim 2, further including an integral ice substitute located in the hollow of the insulated container.
2e. The two-piece insulated container of claim 2 wherein the attaching means is selected from a group consisting of self-locking nylon ties, releasable ties, releasable beaded fasteners, beaded nylon fasteners, cloth belt with a D-ring, belts and buckles, hook and loop ties, peel-and-stick ties, rubber bands, and interference fits.

3. An insulated container for protecting a sprinkler head from heat comprising:
a. an open end with an attracting means for mating the container to a metallic escutcheon or ceiling of a sprinkler head, and
b. the open end has a sealing means for providing a barrier between the open end of the container and the face of the escutcheon or ceiling,
whereby, the container is attached to the sprinkler head unit without impairing the operation of the sprinkler head.
3a. The insulated container of claim 3, further including arrangements taken from a set containing a pop-up indicator, a temperature label, a wireless thermocouple, audible buzzer, or a fiber cable with light emitting diode.
3b. The insulated container of claim 3 wherein the insulated container is manufactured from a material selected from the group consisting of Styrofoam, expanded polystyrene, extruded polystyrene, insulated paper products, plastics, felts, polyurethane foams, crosslinked foam, fiberglass, hemp, plastic foam, or any material that retards the flow of heat.
3c. The insulated container of claim 3 wherein the insulated container is manufactured from a material selected from the group consisting of fiberglass foam composites, composite-reinforced foam, fiber tape reinforced foam, nylon reinforced foam, carbon reinforced foam, paperboard, pressboard, cloth laminated sheet, corrugated board, braided fiberglass, or fiber paper.
3d. The insulated container of claim 1, further including an integral ice substitute located in the hollow of the insulated container.
3e. The sealing means of claim 3 wherein the sealing means is a barrier taken from the group consisting of foams and rubber.
whereby, the sealing force is generated by the attaching means urging the integral seal to tightly seat with the escutcheon or ceiling.
3f. The attracting means of claim 3 wherein the sealing means is taken from the group consisting of magnets, rare earth metals, hook and loop fasteners, frictional, pins, nails, and electrostatic.
